(19) United States
(12) Patent Application Publication
(10) Pub. No.: US 2022/0095441 A1
(43) Pub. Date: Mar. 24, 2022

(54) METHOD OF PROGRAMMING A LIGHT DRIVER IN AN UNOPENED PACKAGE AND RELATED DEVICES

(71) Applicant: ESL Vision, Salt Lake City, UT (US)

(72) Inventors: Michael Brendan Gleeson, Salt Lake City, UT (US); Jeffrey Allen Provolt, Salt Lake City, UT (US)

(73) Assignees: ESL Vision, Salt Lake City, UT (US); ESL Vision, Salt Lake City, UT (US)

(21) Appl. No.: 17/425,664

(22) PCT Filed: Jan. 24, 2020
(86) PCT No.: PCT/US2020/015047

§ 371 Date: Jul. 23, 2021

Related U.S. Application Data
(60) Provisional application No. 62/795,930, filed on Jan. 23, 2019.

(51) Int. Cl. H05B 47/19

(52) U.S. Cl. CPC H05B 47/19; G06F 3/04847

(57) ABSTRACT

A method for programming a light driver in a package. The method includes, while a light driver is disposed in a package and a radio frequency (RF) receiver of the light driver is proximate a RF target marking on the package, receiving, by the RF receiver of the light driver, a RF signal through the package at the RF target marking The RF signal includes one or more operating parameters for programming the light driver. The method further includes storing the one or more operating parameters in memory of the light driver.

### CROSS-REFERENCE TO RELATED APPLICATION

This application is a national phase entry under 35 U.S.C. § 371 of International Patent Application PCT/US2020/015047, filed Jan. 24, 2020, designating the United States of America and published in English as International Patent Publication WO2020/154660 A1 on Jul. 30, 2020, which claims the benefit under Article 8 of the Patent Cooperation Treaty to U.S. Provisional Patent Application Ser. No. 62/795,930, filed Jan. 23, 2019, the disclosure of which is hereby incorporated herein in its entirety by this reference.

### TECHNICAL FIELD

The application relates, generally, to programming a programmable device with radio frequency signals while the programmable device is at least partially positioned in packaging.

### BACKGROUND

Lighting technology is becoming more efficient and advanced based, at least in part, on the use of light emitting diodes (“LEDs”). LED fixtures are often used as alternatives to high-intensity discharge (“HID”), fluorescent and incandescent lighting fixtures. LEDs, among other things, provide lower operating costs, improved lighting levels and longer life span, compared to conventional lighting technologies.

Typically, a LED light fixture includes, among other things, a printed circuit board (“PCB”) and LEDs directly installed/connected in the fixture. As a result, is very difficult and cumbersome for an end user to replace one or more LEDs and/or the PCB board. An end user may desire to “fix” the LED light fixture to adjust lighting parameters (e.g., wattage, brightness, lighting temperature, color, without limitation) or because the LED light fixture is not as desired. This would require the end user to replace one or more LEDs and/or PCB board as described above.

In view of the specific non-limiting examples of disadvantages of LED light systems described above, distributors of LED lighting systems carry numerous LED lighting products having different lighting parameters (e.g., wattage, brightness, lighting temperature, color, without limitation) that have the same form factor. As a result, and by way of a specific non-limiting example, it is common for a distributor to have multiple LED fixtures that have the same form factor but have different color temperature options (e.g., 3000 Kelvin (K), 3500K, 4000K, and 5000K, without limitation) and different wattages (e.g., 30W, 40W, and 50W, without limitation). In the specific scenario described above, a distributor has an inventory of twelve products each having the same form factor.

The inventors of this disclosure appreciate that it is undesirable for a distributor, end user or manufacturer to hold a large number of products each having their own specific lighting configuration. This is burdensome on manageability, cash flow, and inventory space.

Conventionally, as known to the inventors of this disclosure, to change lighting parameters of an LED light fixture (e.g., wattage, brightness, color, lighting temperature, without limitation) that is in packaging, the distributor (or end user) removes the lighting fixture from the packaging. Then, the distributor (or end user) opens up the fixture to access the light driver within the housing of the fixture and programs the light driver to the desired parameters. By way of a specific example, a distributor programs a light driver by connecting the light fixture to a power supply (e.g., AC mains) and using a remote to program the light driver and more generally, the LED light fixture. By way of another specific example, a distributor (or end user) programs the light driver via a dipswitch.

By way of another specific example, in some instances an LED light fixture is programmed via radio frequency (e.g., near-field communication (NFC)). Typically, this may be accomplished if the NFC reader and writer are close to one another without a barrier between them (such a metal housing of a light fixture, without limitation). However, as described above, a distributor (or end user) is required to remove the lighting fixture from the packaging and gain access to the light driver disposed in the housing of the fixture. Moreover, distributors (and end users) do not always have the technical skills and/or time to dissemble an LED light fixture and program the light driver.

For at least the reasons discussed, the inventors of this disclosure appreciate a need to provide for an LED light fixture that is able to be programmed while the fixture remains, at least partially, in its packaging.

### BRIEF DESCRIPTION OF THE DRAWINGS

While this disclosure concludes with claims particularly pointing out and distinctly claiming specific embodiments, various features and advantages of embodiments within the scope of this disclosure may be more readily ascertained from the following description when read in conjunction with the accompanying drawings, in which:

FIG. 1A is a schematic block diagram of an example system for programming an LED light fixture, according to various embodiments of the disclosure.

FIG. 1B is a schematic block diagram of an example system for programming an LED light fixture, in accordance with various embodiments of the disclosure.

FIG. 2 is a schematic of a block diagram of an example NFC target on packaging, according to an embodiment of the disclosure.

FIG. 3 is a schematic of an example housing of a light fixture with a plurality of apertures, according to an embodiment of the disclosure.

FIG. 4 is a schematic of an example user interface, according to an embodiment of the disclosure.

FIG. 5 is a flowchart illustrating an example method for programming a light driver, according to an embodiment of the disclosure.

FIG. 6 is a flowchart illustrating an example method for programming a light driver, according to an embodiment of the disclosure.

FIG. 7 is a diagram of an example user interface that may be used in conjunction with programming a light driver, according to an embodiment of the disclosure.

FIG. 8 is a diagram of an example user interface that may be used in conjunction with programming a light driver, according to an embodiment of the disclosure.

FIG. 9 is a diagram of an example user interface that may be used in conjunction with programming a light driver, according to an embodiment of the disclosure.

FIG. 10 is a schematic of a radio frequency receiver supported by a holder that is coupled to a housing of a light fixture, according to an embodiment of the disclosure.

FIG. 11 is a schematic of a radio frequency receiver supported by a holder, according to an embodiment of the disclosure.

### DETAILED DESCRIPTION

In the following detailed description, reference is made to the accompanying drawings which form a part hereof, and in which is shown by way of illustration specific embodiments in which the disclosure may be practiced. These embodiments are described in sufficient detail to enable those of ordinary skill in the art to practice the disclosure. It should be understood, however, that the detailed description and the specific examples, while indicating examples of embodiments of the disclosure, are given by way of illustration only and not by way of limitation. From this disclosure, various substitutions, modifications, additions rearrangements, or combinations thereof within the scope of the disclosure may be made and will become apparent to those of ordinary skill in the art.

Any characterization in this disclosure of something as ‘typical,’ ‘conventional,’ or ‘known’ does not necessarily mean that it is disclosed in the prior art or that the discussed aspects are appreciated in the prior art. Nor does it necessarily mean that, in the relevant field, it is widely known, well-understood, or routinely used.

The present description may include examples to help enable one of ordinary skill in the art to practice the disclosed embodiments. The use of the terms “exemplary,” “by example,” “by way of example,” “for example,” “e.g.,” and similar wording means that the related description is explanatory, and though the scope of the disclosure is intended to encompass the examples and legal equivalents, the use of such terms is not intended to limit the scope of an embodiment or this disclosure to the specified components, steps, features, functions, or the like.

In accordance with common practice, the various features illustrated in the drawings may not be drawn to scale. The illustrations presented herein are not meant to be actual views of any particular apparatus (e.g., device, system, without limitation) or method, but are merely representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus or all operations of a particular method.

Thus, specific implementations shown and described are only examples and should not be construed as the only way to implement the present disclosure unless specified otherwise herein. Elements, circuits, and functions may be shown in block diagram form in order not to obscure the present disclosure in unnecessary detail. Conversely, specific implementations shown and described are exemplary only and should not be construed as the only way to implement the present disclosure unless specified otherwise herein. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Information and signals described herein may be represented using any of a variety of different technologies and techniques. For example, data, instructions, commands, information, signals, bits, and symbols that may be referenced throughout the description may be represented by voltages, currents, electromagnetic waves, magnetic fields or particles, optical fields or particles, or any combination thereof. Some drawings may illustrate signals as a single signal for clarity of presentation and description. It should be understood by a person of ordinary skill in the art that the signal may represent a bus of signals, wherein the bus may have a variety of bit widths and the disclosure may be implemented on any number of data signals including a single data signal.

It should be understood that any reference to an element herein using a designation such as “first,” “second,” and so forth, does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. In addition, unless stated otherwise, a set of elements may comprise one or more elements.

As used herein, the term “substantially” in reference to a given parameter, property, or condition means and includes to a degree that a person of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

The various illustrative logical blocks, modules, units, and circuits described in connection with the embodiments disclosed herein may be implemented or performed with a general purpose processor, a special purpose processor, a digital signal Processor (DSP), an Application Specific Integrated Circuit (ASIC), a Field-Programmable Gate Array (FPGA) or other programmable logic device, discrete gate or transistor logic, discrete hardware components, or any combination thereof designed to perform the functions described herein.

A general-purpose processor may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer including a processor (general purpose or not) is considered a special-purpose computer while the general-purpose computer is configured to execute computing instructions (e.g., software code) related to embodiments of the present disclosure.

Also, it is noted that the embodiments may be described in terms of a process that is depicted as a flowchart, a flow diagram, a structure diagram, or a block diagram. Although a flowchart may describe operational acts as a sequential process, many of these acts may be performed in another sequence, in parallel, or substantially concurrently. In addition, the order of the acts may be re-arranged. A process may correspond to a method, a thread, a function, a procedure, a subroutine, or a subprogram, without limitation. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

As used herein, “radio frequency signal” and “RF signal” are used to mean wireless signals suitable to communicate data and/or power. The wireless signals may include, but are not limited to, frequency bands that are associated with communication standards. As non-limiting examples, the communication standards may include near-field communication (NFC), Wi-Fi, and BLUETOOTH®.

Embodiments of the disclosure include a method for programming a light driver, which may be at least partially positioned in a package. The method includes, while a light driver is disposed at least partially in a package and a radio frequency (RF) receiver of the light driver is proximate an RF target marking on the package: (1) receiving, by the RF receiver of the light driver, a RF signal through the at least a portion of the package at the RF target marking , wherein the RF signal includes one or more operating parameters for programming the light driver; and (2) storing the one or more operating parameters in memory of the light driver.

Embodiments of the disclosure include a method for programming a light driver at least partially positioned in a package (e.g., an unopened package or a partially opened package). The method includes, while a light driver is disposed at least partially in a package, the light driver is programmed with a first operating parameter to control lighting of a light emitting diode (LED), and a RF receiver of the light driver is proximate a RF target marking on the package: (1) receiving, by the RF receiver of the light driver, a RF signal through at least a portion of the package at the RF target marking , wherein the RF signal includes a second operating parameter to control light of the LED; and (2) storing the second operating parameter in memory of the light driver.

Embodiments of the disclosure include a light packaging assembly that includes a package comprising a RF target marking, and an RF receiver and a light driver disposed within the package proximate the RF target marking. A light driver may be further disposed within a housing. In some embodiments, an RF receiver is incorporated into a light driver or a system including a light driver, and both the light driver and the RF receiver are disposed within a housing. As a non-limiting example, the light driver and the RF receiver may both be implemented in a microcontroller. In some embodiments, an RF receiver is disposed outside a housing and electrically coupled to a light driver. As a non-limiting example of such an arrangement, the light driver and the RF receiver may each be implemented in separate and distinct integrated circuits or microcontrollers that are operably coupled for a data and power communication via one or more respective input/output (I/O) pins.

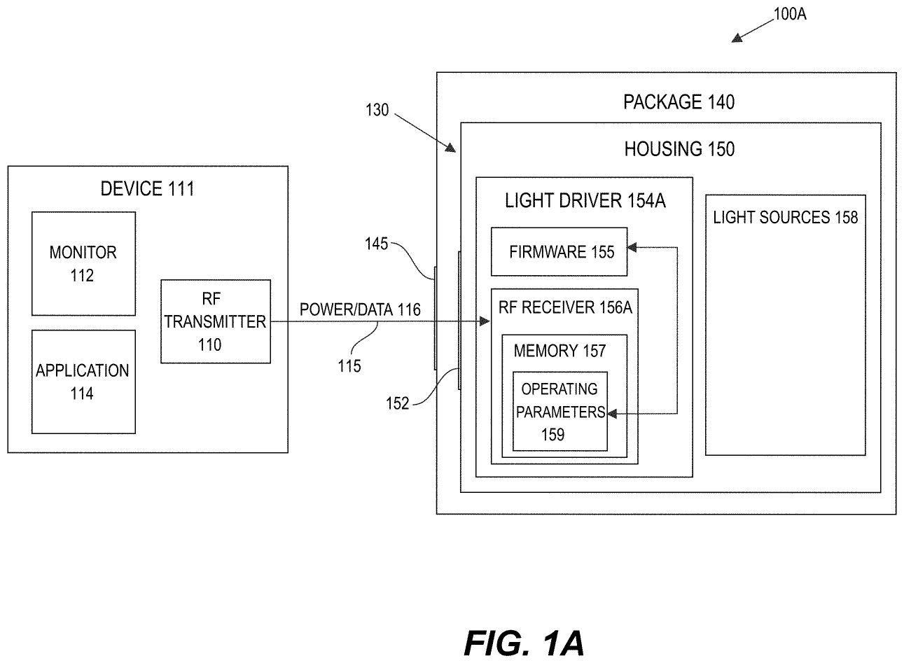

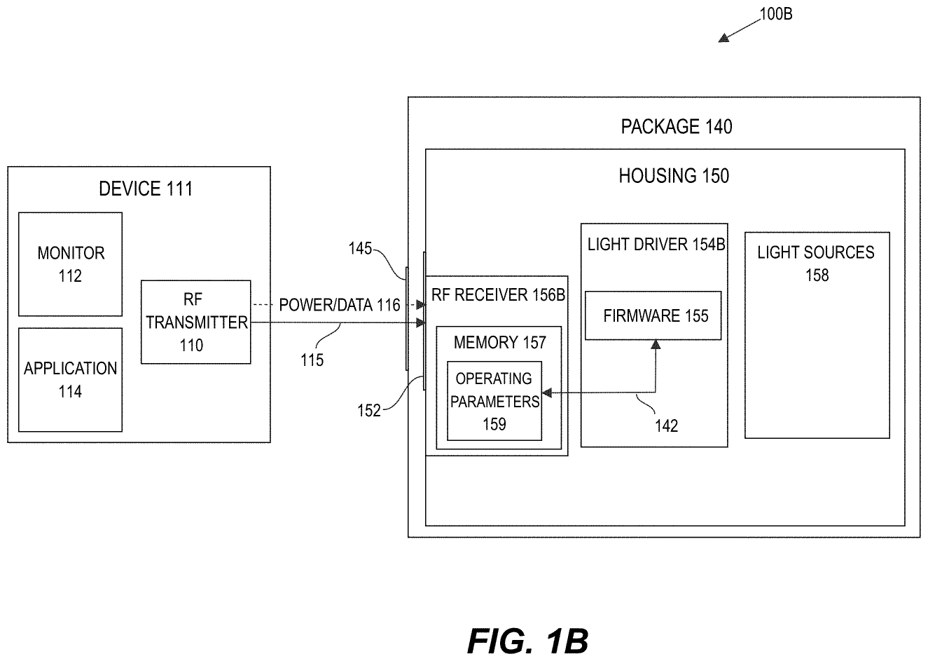

FIG. 1A and FIG. 1B depict light packaging and programming system 100A and 100B, respectively, in accordance with one or more embodiments. FIG. 1A depicts an embodiment of a light packaging assembly where a light driver includes an RF receiver. FIG. 1B depicts an embodiment of a light packaging and programming system where an RF receiver is positioned externally to light driver and housing, and the RF receiver and light driver are operably coupled by a wired data and power connection.

In the specific example depicted by FIG. 1A, light packaging and programming system 100A includes device 111 and package 140. Package (also referred to herein as “packaging”) 140 may include a programmable light fixture 130 that includes a housing 150, a light driver 154A and light sources 158 as described herein.

Device 111 is configured, generally, to wirelessly couple with light driver 154A such that power and data 116 may be transferred from device 111 to light driver 154 over RF signal 115 (e.g., RF signal 115 may be a carrier wave suitable for transferring power and for transferring data between light driver 154 and device 111, without limitation). Additionally or alternatively, device 111 is configured, generally, to provide user interfaces for controlling the programming of light driver 154A via data transferred via RF signals 115. As non-limiting examples, data transferred via RF signals 115 may include operating parameters for light driver 154 and a light fixture more generally.

Device 111 may include RF transmitter 110 for wirelessly coupling with light driver 154A via RF signals 115. Device 111 may include an application 114 that, when executed by a computer processor (not shown), enables device 111 to perform one or more of the features and functions of programming light driver 154A described herein. Device 111 may include monitor 112 (e.g., a monitor or display, without limitation) for providing (e.g., by application 114, without limitation) one or more user interfaces for controlling programming of light driver 154A described herein.

Light driver 154A is configured, generally, to control light sources 158 in response to one or more operating parameters 159. Light driver 154A may include an RF receiver 156A for wirelessly coupling with device 111, and more specifically RF transmitter 110, via RF signals 115. RF receiver 156A may include memory 157 (i.e., a non-transitory computer readable memory) for storing operating parameters 159. Light driver 154A may include firmware 155 stored in a memory (memory 157 or another memory that is not shown) and that, when executed, accesses and uses operating parameters 159 to control light sources 158 as described herein. Non-limiting examples of non-transitory computer readable memory include volatile and non-volatile memory. A non-limiting example of volatile memory is Random Access Memory (RAM), without limitation. A non-volatile memory (also referred to as non-volatile storage) is computer readable memory from which stored information may be retrieved after having been power cycled (i.e., on, off, on). Non-limiting examples of non-volatile memory include Resistive RAM (ReRAM), Flash memory (and floating-gate memory cells more generally), Read Only Memory, Erasable Programmable ROM (EPROM), Electronically Erasable Programmable ROM (EEPROM), ferroelectric RAM, and magnetic computer storage devices (e.g., hard disk drives, floppy disks, and magnetic tape, without limitation). In a preferred embodiment, memory 157 is or includes one or more non-volatile memories.

FIG. 1A depicts housing 150 of light packaging and programming system 100A disposed in package 140. More specifically, as will be described in further detail below, driver 154 of the light fixture is programmable while at least partially disposed in package 140 (i.e., programmable while at least partially disposed in unopened or partially opened package 140).

For clarity and brevity, FIG. 1A depicts housing 150 (as well as components disposed in housing 150) of the light fixture and does not depict other components of the light fixture (e.g., printed circuit board (PCB), light shade, without limitation).

It should be appreciated that the term “housing,” as described herein, may also be interchangeably with the term “light fixture.” A housing or light fixture, as described herein, is any lighting assembly that includes at least a light emitting source (e.g., light sources 158, without limitation) and a driver (e.g., light driver 154, without limitation) for controlling the lighting parameters of the light emitting source. A housing may be one of, or a combination of, various materials including RF signal impeding materials and/or structures that degrade power and/or data communicated by RF signals. Examples of RF signal impeding materials include, but are not limited to, metal (e.g., aluminum, steel, without limitation), plastic, and ceramic, without limitation. Examples of RF signal impeding structures include, but are not limited to, solid walls of RF signal impeding materials that are of a thickness or include features to impede RF signals, while in some cases a different (smaller) thickness would not impede RF signals. Impeding may include reflecting, blocking, and/or grounding of RF signals, without limitation.

Light sources 158 may be any number of light emitting diodes (LEDs), plasma lighting, laser lighting, lighting based on use of semiconductor element as a light emitting surface, and combinations thereof, without limitation. As non-limiting examples, light sources 158 may be arranged in various patterns. For example, LEDs may be arranged linearly or arranged in other patterns such as a circular pattern, square pattern, rectangle pattern, without limitation.

In various embodiments, individual light sources 158 may be attached or electrically coupled to a PCB (not shown). In various embodiments, light sources 158 may include a Kelvin color temperature (i.e., exhibit or be characterizable by a Kelvin (K) color temperature). For example, light sources 158 may operate in a range of color temperatures, such as, but not limited to, 2700K to 5000K. It should be appreciated that light sources 158 may operate lower than 2700K and greater than 5000K. Moreover, light sources 158 may operate at various wattages such as, but not limited to, 12 Watts (W) to 30 W. It should be appreciated that light sources 158 may operate at wattages less than 12 W or greater than 30 W.

In various embodiments, light driver 154A performs at least two main functions. First, driver 154 converts high voltage alternating current (AC), such as AC mains, to a power source appropriate to supply light sources 158, such as a low power direct current (DC), without limitation. Second, light driver 154 protects light sources 158 from voltage or current fluctuations by regulating the power. For example, a change in voltage may cause a change in the current supplied to light sources 158. As a non-limiting example, LED light output is proportional to its current supply, and LEDs are often rated to operate within a certain current range (measured in amperes). Too much current or too little current may cause light output to vary or cause the LEDs to degrade faster due to higher temperatures within the LED. So, light driver 154 may regulate the supplied power by regulating the supply current and thereby ensure correct wattage and light output.

As mentioned above, in some embodiments light driver 154A is an internal driver, such as the specific example depicted by FIG. 1A, where light driver 154A is disposed within housing 150. Housing 150 is a single unit that houses light sources 158 and light driver 154A.

In another embodiment not depicted by FIG. 1A or 1B, a light driver is an external driver, i.e., disposed outside of housing 150. As a non-limiting example, a light driver is external to a housing of an LED light fixture (e.g., not disposed in and separate from the internal region of the housing of the light fixture where light sources 158 are disposed, without limitation). In such an embodiment, a light driver is electrically coupled to a light fixture and light sources 158 therein.

RF receiver 156A is configured, generally, to receive RF signals, including RF signal 115 provided by RF transmitter 110. In the specific example depicted in FIG. 1A, an antenna (not shown) of RF receiver 156A receives RF signal 115 transmitted via an antenna (not shown) of RF transmitter 110. In one embodiment, RF receiver 156 is a near-field communication (NFC) receiver (or NFC reader) and RF transmitter 110 is an NFC transmitter (or NFC writer).

In various embodiments, RF receiver 156 is an NFC transceiver and RF transmitter 110 is an NFC transceiver. As such, in some embodiments, RF transmitter 110 and RF receiver 156 may be configured to bi-directionally read/write to one another.

In some embodiments, an aperture 152 is defined by an external wall of housing 150 and RF receiver 156B is arranged proximate the aperture 152 to facilitate establishing wireless connections including wireless connections with RF transmitter 110.

In the example depicted by FIG. 1B, RF receiver 156B is arranged flush with aperture 152. In the example depicted by FIG. 1A, RF receiver 156 is not arranged flush with aperture 152, i.e., RF receiver 156A of FIG. 1A is spaced from aperture 152. In some embodiments, at least a portion of RF receiver 156B may protrude through aperture 152.

In various embodiments, housing 150 may comprise a material such as a metal, metal alloy, plastic, ceramic, a composite material, and combinations thereof, without limitation. RF signals, such RF signal 115, are unable to pass through some materials of housing 150, such as metal housing, without limitation. As such, external RF signals may not be received within the metal housings of some conventional LED light fixtures.

In various embodiments, aperture 152 enables RF signal 115 to be received by RF receiver 156 when RF receiver 156 is disposed within a region of housing 150. In some embodiments, aperture 152 is a single opening in housing 150. In some embodiments, aperture 152 is a plurality of openings defined in housing 150. In some embodiments, aperture 152 includes a window (now shown) comprised of a material (e.g., plastic, glass, without limitation) and that enables RF signal 115 to pass through and be received by RF receiver 156. In some embodiments, a single window covers a plurality of apertures.

As depicted in FIG. 1A and FIG. 1B, housing 150 is disposed in package 140. Package 140, in one embodiment, is a sales package to protect the light fixture during shipping and to ensure safe handover to the consumer. A sale package, as described herein, is any type of packaging used to protect the lighting fixture and used to display the lighting fixture for sale to end user. Package 140 is made of a material that allows for RF signals (e.g., NFC signals) to pass through. For example, package 140 is a box made of cardboard. In various embodiments, package 140 is made of any material (e.g., plastic) that enables RF signals (e.g., NFC signals) to pass through.

It should be appreciated that upon a light fixture 130 being placed in package 140, package 140 is closed or sealed. Package 140 includes RF target markings 145 marked on an outside surface of package 140. RF target markings 145 provides a visual target that enables a user of device 111 that includes RF transmitter 110, to direct RF signal 115 through package 140 at the RF target and through aperture 152 to RF receiver 156.

In the specific example depicted by FIG. 1B, RF receiver 156B is separate from light driver 154B thereby enabling RF receiver 156B to be arranged flush with aperture 152 defined in a wall of housing 150. A wired connection 142 for data transfer operably couples RF receiver 156B and light driver 154B. More specifically, firmware 155, while executed by light driver 154B, may access and use operating parameters 159 via wired connection 142.

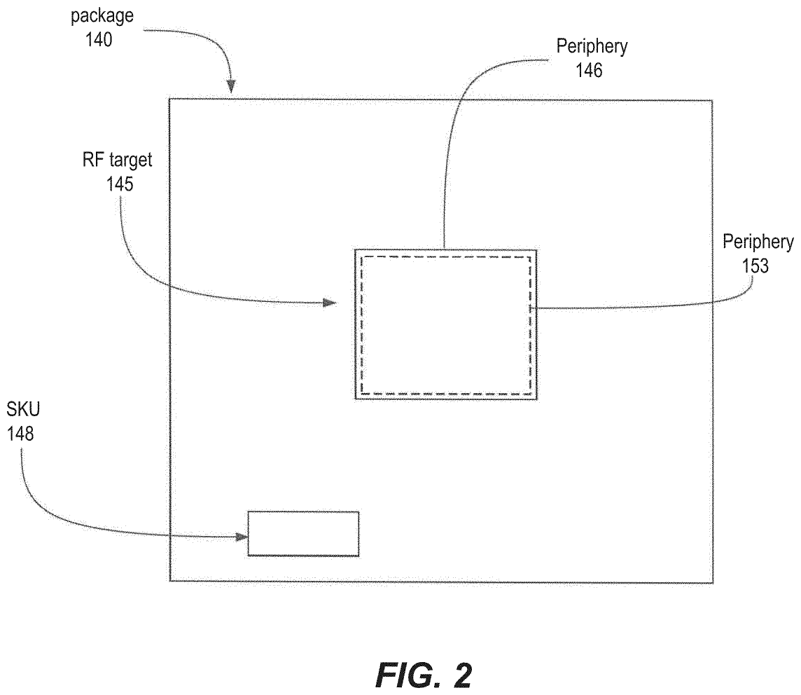

FIG. 2 depicts a side view of package 140 of packaging and programming system 100A or 100B, in accordance with one or more embodiments. As depicted by FIG. 2, periphery 153 of aperture 152 is within a periphery 146 of RF target markings 145. In one embodiment, periphery 146 overlaps periphery 153. In another embodiment, periphery 153 is centered with periphery 146. In another embodiment, periphery 153 is larger than periphery 146. It should be appreciated that RF target markings 145 may be any shape such as oval, circular, rectangular, without limitation. Likewise, it should be appreciated that periphery 153 of aperture 152 may be any shape such as oval, circular, rectangular, without limitation.

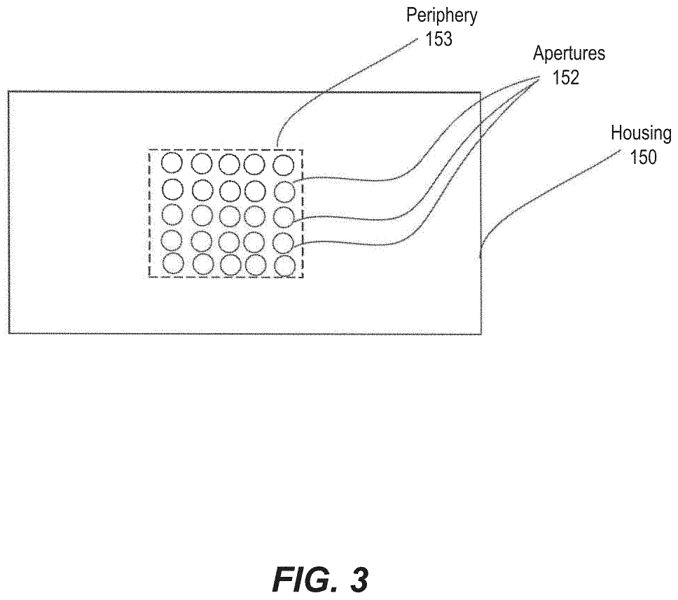

FIG. 3 depicts a side view of housing 150 including a plurality of apertures 152 within periphery 153, in accordance with one or more embodiments. For example, apertures 152 are a plurality of through-holes in housing 150. The apertures may be arranged in a pattern (as depicted in FIG. 3) or may be randomly defined within periphery 153.

Turning back to FIG. 2, in some embodiments, package 140 may include stock keeping unit (SKU) markings 148 marked on an outside surface of package 140. SKU markings 148, in various embodiments, may be marked on any surface of package 140.

Turning back to FIG. 1A and FIG. 1B, operating parameters 159 are parameters that light driver 154 uses to control the operation of light sources 158. The operating parameters 159 may be one or more of wattage and Kelvin color temperature, without limitation. For example, operating parameters 159 (or LED settings) of 3000K color temperature and 12 W to program the driver such that light sources 158 operate at 3000K and 12 W. As noted above, operating parameters 159 may be included in data of power and data 116 communicated via RF signal 115.

Upon RF receiver 156 receiving RF signal 115, operating parameters 159 are stored in memory 157. In a non-limiting example where an RF signal 115 includes an NFC signal, the NFC signal provides sufficient power to RF receiver 156 such that RF receiver is able to receive RF signal 115 via an antenna of the RF receiver 156. Additionally, RF receiver 156 is configured to store operating parameters 159 received via power and data 116 via RF signal 115 in memory 157. In various embodiments, RF receiver 156 is a passive component. That is, RF receiver 156 does not have a local power source. As a non-limiting example, RF receiver 156 may not have a local power source because light fixture 130 is in package 140 and is not able to be powered on, for example, by AC mains. Accordingly, RF receiver 156 is induced with the requisite power by RF signal 115 to receive and store operating parameters 159 in memory 157.

In one embodiment, initial operating parameters for light fixture 130 may be stored in memory 157, and the initial operating parameters may be replaced by operating parameter 159 received from device 111. For example, light driver 154 may be initially programmed with operating parameters of 5000K and 30 W during manufacturing of the light fixture. While package 140 is at a distributor, the distributor reprograms light driver 154 with operating parameters 159 (e.g., 3000K and 12 W) that replaces the initial operating parameters. Upon removing the light fixture from package 140 and installation of light fixture 130, light sources 158 operate according to operating parameters 159 (e.g., 3000 K and 12 W) received from RF transmitter 110, and device 111 more generally, rather than the initial operating parameters programmed at the manufacturing site of light fixture 130.

In various embodiments, device 111 may be an electronic device, such as, but not limited to, a smart phone, tablet computer, personal computer, or a proprietary programming tool. Device 111 includes monitor 112. Monitor 112 may be a display such as a liquid crystal display, plasma display, or e-ink display, without limitation. In some embodiments, the display may be a touch screen display. In various embodiments, monitor 112 is configured to present a user-interface (UI) (e.g., a graphical user interface) of application 114, the UI configured to enable a user to select one or more operating parameters 159 that are sent to driver 154 via RF signal 115.

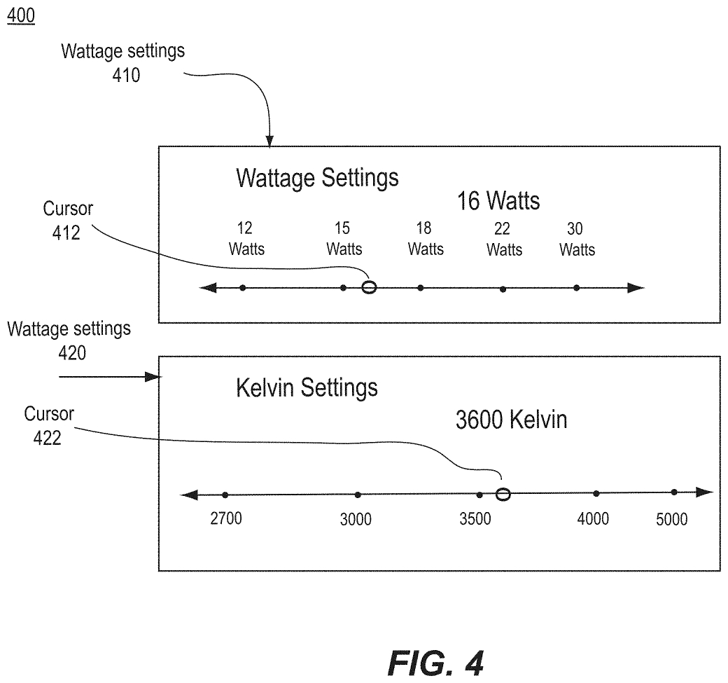

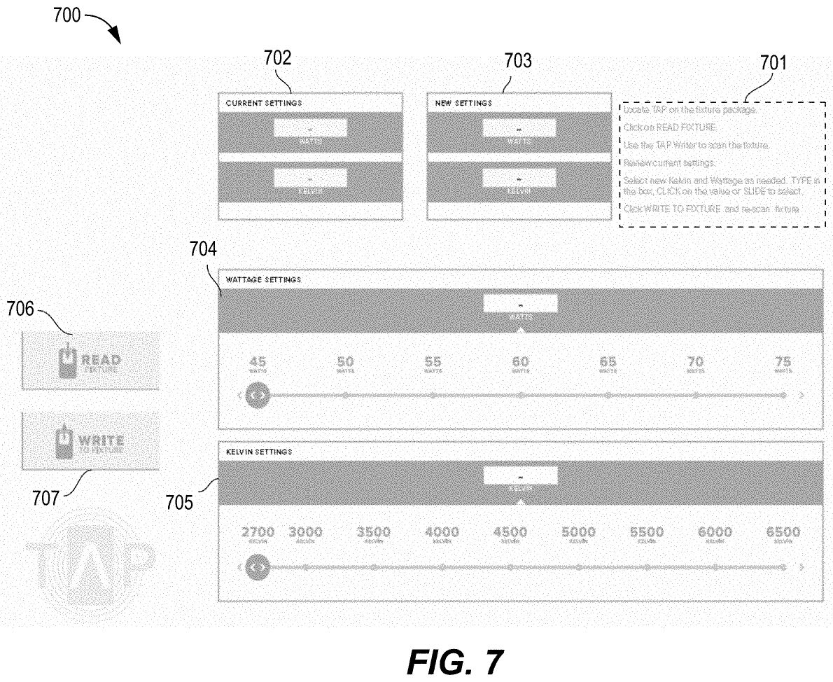

In one embodiment, RF transmitter 110 is disposed in a wand device that is releasably coupled to device 111. While coupled to device 111, the wand device and more specifically RF transmitter 110 are in electrical and data communication with device 111. As a non-limiting example, such a wand device is coupled to device 111 via a communication interface such as a universal serial bus (USB). While coupled to device 111, a user may select one or more operating parameters via the UI (e.g., UI 400 of FIG. 4 and/or the UI of FIGS. 7-10). Upon selection of one or more operating parameters, the wand is decoupled from the computer and placed proximate RF target markings 145. As a result, a wireless connection is formed via RF signal 115 with RF receiver 156, and data 116 and power (that includes operating parameters 159) is transmitted through aperture 152 and received by RF receiver 156.

FIG. 4 depicts UI 400 displayed on monitor 112 (see FIGS. 1A and 1B). UI 400 includes wattage settings 410 and Kelvin settings 420. The wattage range of wattage settings 410 may be 12 W to 30 W. However, the wattage range may be greater or less than the depicted range. A user selects and moves a cursor 412 to the desired wattage setting (e.g., ˜15 W). Upon selection, RF signal 115 includes the selected wattage setting.

The Kelvin (color temperature) range of the Kelvin settings 420 may be 2700K to 5000K, in another embodiment, 2700K to 6500K. However, the Kelvin range may be greater or less than the depicted range. A user selects and moves a cursor 422 to the desired Kelvin settings (e.g., ˜3500K). Upon selection, RF signal 115 includes the selected Kelvin setting.

Upon the user selecting the desired operating parameters for the light fixture in package 140, the user places RF transmitter in close proximity (e.g., 10 centimeters) to RF receiver 156. For example, the user places device 111 directly on the wall and faces RF transmitter 110 on RF target markings 145 such that RF signal 115 (that includes operating parameters 159) passes through aperture 152 and received by RF receiver 156.

UI 400 may include other operating parameters such as, but not limited to, wattage consumption. Driver 154, in one embodiment, is able to detect and control wattage consumption of Light sources 158. As such, a user may select the amount of wattage the LEDs consume such as the amount of wattage per time (e.g., 1000 W/day). In various embodiments, upon the driver detecting that the LEDs have consumed (or about to consume) the selected wattage usage, the driver may turn off the LEDs or dim the LEDs. In one embodiment, upon the driver detecting that the LEDs have consumed (or about to consume) selected wattage usage, a message is sent to device 111 indicating that the LEDs have reached (or about reached) the selected amount of wattage usage. In one embodiment, a RF transceiver (e.g., a BLUETOOTH® transceiver) transmits the message to device 111, for example, to a RF transceiver (e.g., a BLUETOOTH® transceiver) of device 111.

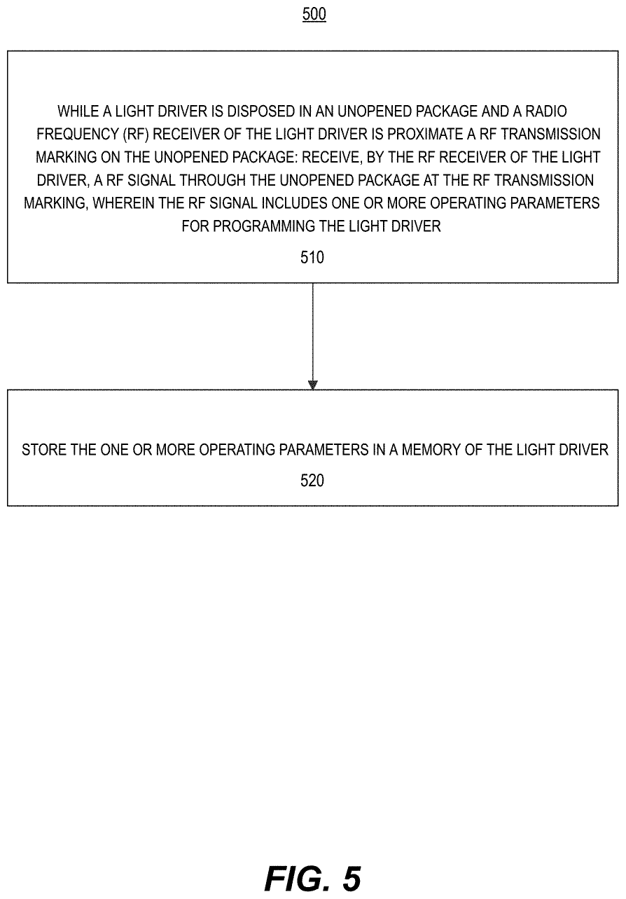

FIG. 5 is a flowchart of a method 500 for programming a light driver, which is at least partially positioned in a package (e.g., an unopened or partially opened package), according to one or more embodiments.

At 510 of method 500, while a light driver is at least partially disposed in a package and an RF receiver of the light driver is proximate an RF target marking on the package, data and power is communicated via an RF signal received by the RF receiver of the light driver. The RF signal is received through at least a portion of the package at the RF target marking. The data communicated via the RF signal includes one or more operating parameters for programming the light driver. For example, while a light fixture (that includes housing 150) is within package 140, RF transmitter 110 is placed in proximity to RF target markings 145 of package 140. RF signal 115 (that includes operating parameters) is transmitted through RF target and through aperture 152 and received by RF receiver 156.

At 520, the one or more operating parameters are stored in memory of the light driver. For example, operating parameters 159 transmitted via RF signal 115 are received by RF receiver 156 and stored in memory 157. Accordingly, driver 154 is programmed to operate LEDs via operating parameters 159. For example, when the light fixture is powered on (e.g., by AC mains) driver 154 operates LEDs via operating parameters 159.

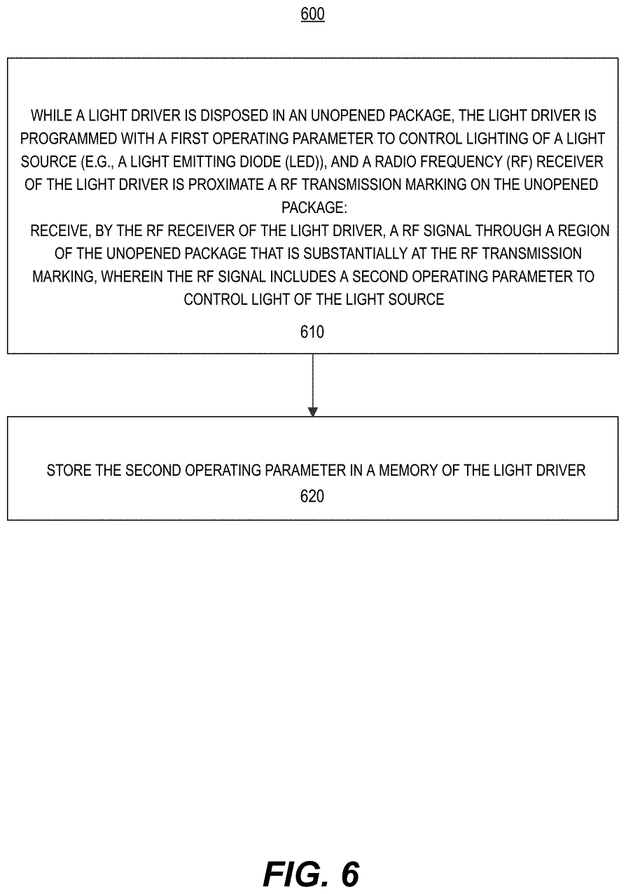

FIG. 6 is a flowchart of a method 600 for programming a light driver, which is at least partially positioned in a package (e.g., an unopened or partially opened package), according to one or more embodiments. At 610 of method 600, while a light driver is disposed in a package, the light driver is programmed with a first operating parameter to control lighting of a LED, and a RF receiver of the light driver is proximate a RF target marking on the package, the RF receiver receives a RF signal through the at least a portion of the package at the RF target marking. The RF signal includes a second operating parameter to control light of the LED. For example, while a light fixture (that includes housing 150) is within package 140, RF transmitter 110 is placed in proximity to RF target markings 145 of package 140. RF signal 115 (that includes the second operating parameters) is transmitted through RF target and through aperture 152 and received by RF receiver 156.

At 620, the one or more operating parameters are stored in memory. For example, operating parameters 159 transmitted via RF signal 115 are received by RF receiver 156 and stored in memory 157. Accordingly, driver 154 is programmed to operate LEDs via operating parameters 159. For example, when the light fixture is powered on (e.g., by AC mains) driver 154 operates LEDs via operating parameters 159.

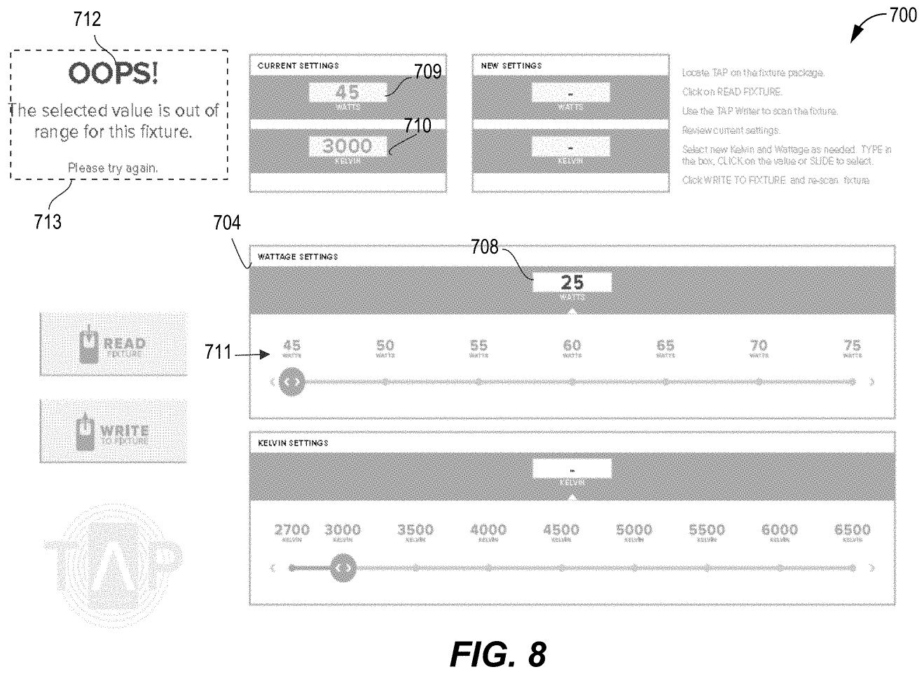

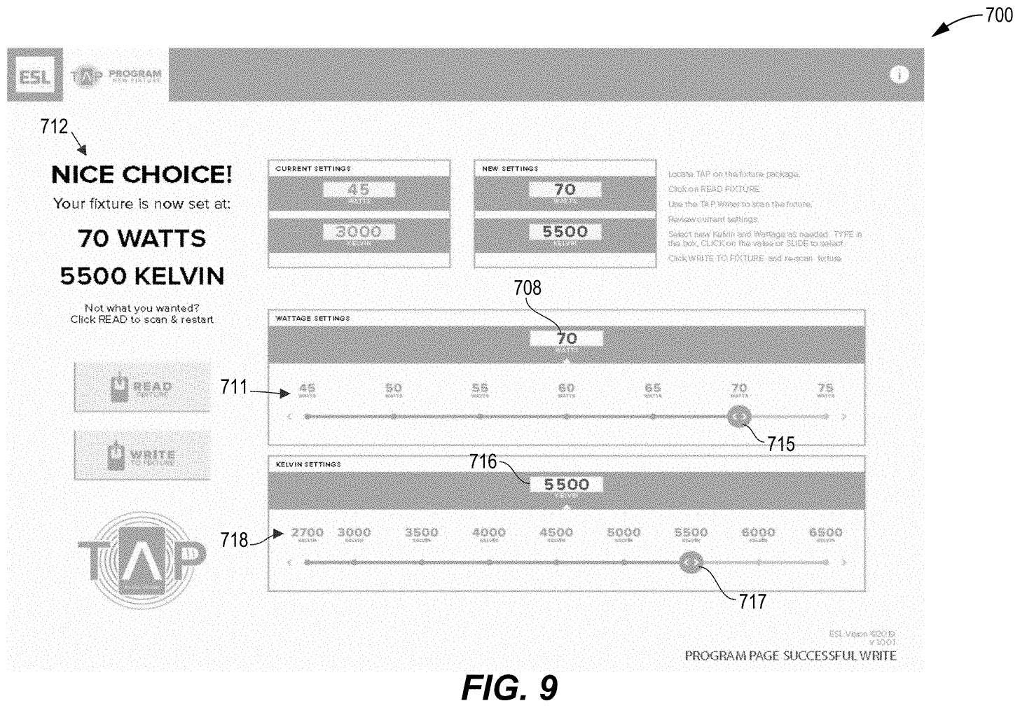

FIG. 7, FIG. 8 and FIG. 9 depict a user interface during phases of a contemplated operation of a method of programming a light driver such as method 500 or method 600, in accordance with one or more embodiments. In the specific example depicted by FIG. 7, UI 700 includes an instructions text box 701, a current settings frame 702, a new settings frame 703, a read fixture button 706, a write to fixture button 707, a wattage setting frame 704 and a kelvin setting frame 705. Instructions text box 701 provides instructions for using UI 700 to control programming of a light driver in accordance with one or more embodiments. Current setting frame 702 includes fields for displaying current settings to a user of UI 700. New settings frame 703 includes fields for displaying new settings to a user of UI 700. Wattage settings frame 704 includes a slide bar for selecting a value for a wattage setting and field for displaying a selected wattage setting value. Kelvin settings frame 705 includes a slide bar for selecting a value for a kelvin setting and a field for displaying a selected kelvin setting value. Read fixture button 706 is configured to cause application 114 to initiate a wireless connection with a light driver 154 via RF signal 115 and read current operating parameters stored in memory 157. Once received, the operating parameters are displayed at current settings frame 702. Write to fixture button 707 is configured to cause application 114 to initiate a wireless connection with a light driver 154 via RF signal 115 and write new operating parameters to memory 157 including the selected wattage setting value and selected kelvin setting value. Once a write operation is complete, the selected wattage setting value and selected kelvin setting value may be displayed at new settings frame 703.

FIG. 8 depicts a specific example where a selected wattage value is outside a wattage range for a light driver. In the example contemplated by FIG. 8, current operating parameters have already been read and values of ‘45’ and ‘3000’ are displayed in current settings frame 702 in the current watts setting field 709 and the current kelvin setting field 710, respectively. A value has been entered into a selected watts settings field 708, here ‘25.’ The value is outside the wattage range 711 hard coded into application 114 and which are displayed at wattage settings frame 704. In other embodiments, direct value entry at selected watts settings field 708 may be disabled, and values may only be entered by manipulating a slider or other selection element of wattage settings frame 704. Application 114 detects that the value ‘25’ entered at selected watts settings field 708 is outside the wattage range 711 for light driver 154 and so causes UI 700 to alert the user with an error message 712 displayed in an error message text box 713. In some embodiments, when a value outside the wattage range is entered at selected watts settings field 708, application 114 will ignore selection of write to fixture button 707 that would otherwise cause new operating parameters to be written to a light driver 154.

FIG. 9 depicts a specific example where a selected wattage value is within a wattage range for a light driver. In the example contemplated by FIG. 9, a value has been entered into a selected watts settings field 708, here ‘70’ that is within a wattage range 711 for light driver 154. In this case, the value corresponds to a value selected using watts selection slide bar 715. Similarly, a value has been entered into selected kelvin setting field 716, here ‘5500,’ that is within a kelvin range 718 for light driver 154. In this case, the value corresponds to a value selected using kelvin selection slide bar 717.

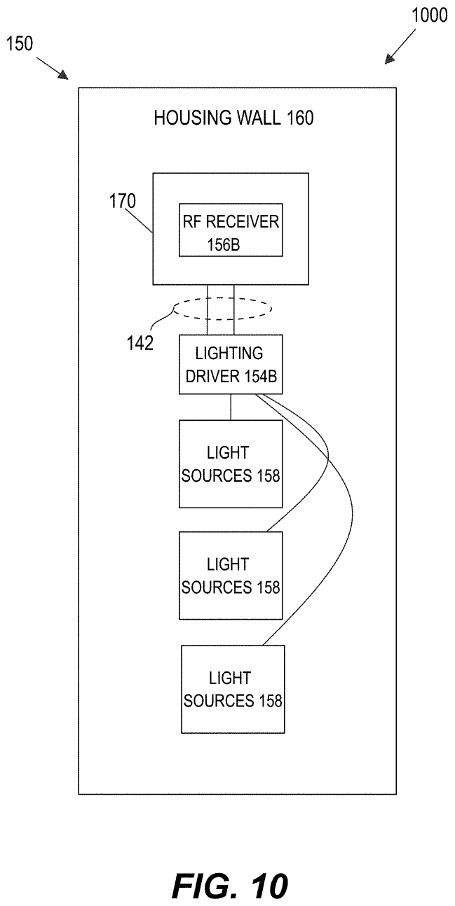

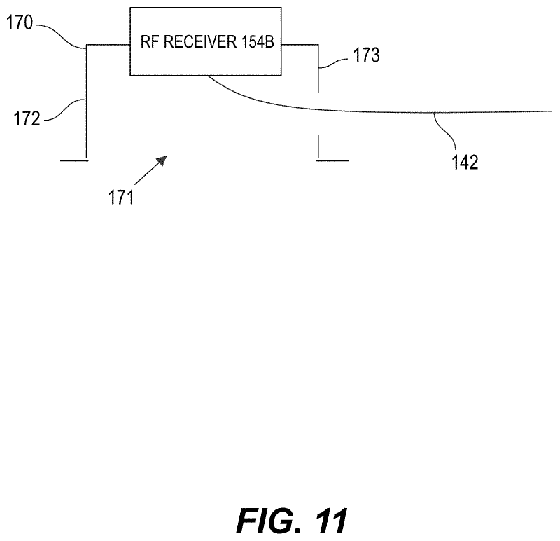

FIG. 10 and FIG. 11 depict an arrangement of a programmable lighting fixture 1000 where a holder 170 is used to position RF receiver 156B at a specific location within housing 150 (i.e., relative to a portion of housing 150 that is intended to be near RF target markings 145) to space RF receiver 156B from a housing wall 160 of housing 150, and to create a cable guide space 171 for cables 142 from RF receiver 156B to light driver 154B and from light driver 154B to lighting sources 158.

FIG. 10 is a top down view of an RF receiver 156B fitted into holder 170 that is in turn coupled (e.g., fastened or affixed, without limitation) to a housing wall 160 of a housing 150 of a programmable lighting fixture 1000, in accordance with one or more embodiments. FIG. 11 is a side view of a portion of the programmable lighting fixture 1000, such that a side view of the RF receiver 156B fitted within a space defined on a surface of holder 170 is depicted. A cable guide space 171 is defined by a top surface of holder 170 that is formed to receive at least a portion of RF receiver 156B and support structures of holder 170 that extend between the top surface and flanges that may be coupled to housing wall 160 of housing 150. A cable receiving aperture 172 is defined in support structure 173 of holder 170, and cables 142 for operable coupling of RF receiver 156B to lighting driver 154B are able to pass through.

While certain illustrative embodiments have been described in connection with the figures, those of ordinary skill in the art will recognize and appreciate that the scope of this disclosure is not limited to those embodiments explicitly shown and described in this disclosure. Rather, many additions, deletions, and modifications to the embodiments described in this disclosure may be made to produce embodiments within the scope of this disclosure, such as those specifically claimed, including legal equivalents. In addition, features from one disclosed embodiment may be combined with features of another disclosed embodiment while still being within the scope of this disclosure, as contemplated by the inventors.

In some embodiments, the software portions are stored in a non-transitory state such that the software portions, or representations thereof, persist in the same physical location for a period of time. Additionally, in some embodiments, the software portions are stored on one or more non-transitory storage devices, which include hardware elements capable of storing non-transitory states and/or signals representative of the software portions, even though other portions of the non-transitory storage devices may be capable of altering and/or transmitting the signals. Examples of non-transitory storage devices are Flash memory and random-access-memory (RAM). Another example of a non-transitory storage device includes a read-only memory (ROM) which may store signals and/or states representative of the software portions for a period of time. However, the ability to store the signals and/or states is not diminished by further functionality of transmitting signals that are the same as or representative of the stored signals and/or states. For example, a processor may access the ROM to obtain signals that are representative of the stored signals and/or states in order to execute the corresponding software instructions.

While the present disclosure has been described herein with respect to certain illustrated embodiments, those of ordinary skill in the art will recognize and appreciate that the present invention is not so limited. Rather, many additions, deletions, and modifications to the illustrated and described embodiments may be made without departing from the scope of the invention as hereinafter claimed along with legal equivalents thereof. In addition, features from one embodiment may be combined with features of another embodiment while still being encompassed within the scope of the invention.

1. A method of programming a light driver in an unopened package, the method comprising:
while a light driver is at least partially disposed in a package and a radio frequency (RF) receiver operably coupled to the light driver is proximate a RF target marking on the package:
receiving, by the RF receiver, a RF signal through the package at the RF target marking, wherein the RF signal includes one or more operating parameters for programming the light driver; and
storing the one or more operating parameters in a memory accessible by the light driver.

2. The method according to claim 1, wherein receiving the RF signal comprises receiving the RF signal through one or more apertures of a housing proximate the RF target marking.

3. The method according to claim 1, wherein receiving the RF signal comprises receiving the RF signal through one or more apertures of a housing proximate the RF target marking, wherein the housing comprises the light driver and a light source controlled by the light driver.

4. The method according to claim 1, wherein receiving the RF signal comprises receiving one or more operating parameters comprising one or more of wattage settings and color temperature settings.

5. The method according to claim 1, further comprising:
programming the light driver with the one or more operating parameters.

6. The method according to claim 1, further comprising:
programming the light driver with the one or more operating parameters by replacing an original value of an operating parameter with a new value of the one or more operating parameters.

7. The method of claim 6, further comprising:
receiving, by the RF receiver, a second RF signal through the package at the RF target marking, wherein the second RF signal includes a second operating parameter to control light of a light source; and
storing the second operating parameter in memory accessible by the light driver.

8. The method according to claim 7, further comprising:
programming the light driver to operate the light source with the second operating parameter, wherein a second value of the second operating parameter replaces the new value of the one or more operating parameters.

9. The method according to claim 7, wherein receiving the second RF signal comprises receiving the RF signal through one or more apertures defined by a wall of a housing, the aperture proximate the RF target marking.

10. The method according to claim 7, wherein receiving the second RF signal comprises receiving the second RF signal through one or more apertures of a housing proximate the RF target marking, wherein the housing comprises the light driver and a light emitting diode (LED) controlled by the light driver.

11. The method according to claim 7, wherein receiving the second RF signal comprises receiving one or more operating parameters comprising one or more of wattage settings and Kelvin settings.

12. The method according to claim 7, wherein receiving the second RF signal comprises receiving the RF signal through an unopened package comprising a stock keeping unit (SKU) marking.

13. A programmable light fixture packaging assembly, comprising:
a package comprising a radio frequency (RF) target marking;
a light driver disposed within the package; and
an RF receiver operably coupled to the light driver, wherein the RF receiver is disposed proximate the RF target marking.

14. The programmable light fixture packaging assembly of claim 13, further comprising a housing comprising:
the light driver; and
an aperture, wherein the RF receiver is proximate the aperture and flush with the housing, and wherein a periphery of the RF target marking aligns with a periphery of the aperture.

15. The programmable light fixture packaging assembly of claim 13, further comprising a housing comprising:
the light driver; and
apertures proximate one another, wherein the RF receiver is proximate the apertures, and wherein a periphery of the RF target marking aligns with a periphery of the apertures.

16. The programmable light fixture packaging assembly of claim 13, further comprising:
a stock keeping unit (SKU) marking on the package.

17. A light system, comprising:
a housing comprising one or more apertures defined in a housing wall and positioned proximate to one another;
a light driver disposed within the housing;
a radio frequency (RF) receiver disposed proximate the apertures and within the housing, wherein the RF receiver is configured to receive a RF signal through the one or more apertures and the RF signal comprises one or more operating parameters associated with the light driver; and
at least one light source disposed within the housing, wherein the at least one light source is operable by the light driver in response to the one or more operating parameters.

18. The light system of claim 17, wherein the one or more apertures are arranged in a pattern, wherein the RF receiver is positioned relative to the one or more apertures such that a periphery of the RF receiver is within a periphery of the pattern in which the one or more apertures are arranged.

19. The light system of claim 17, wherein the RF signal comprises one or more operating parameters, the operating parameters comprising one or more of: wattage settings and color temperature settings.
